(19) United States
(12) Patent Application Publication
(10) Pub. No.: US 2013/0179282 A1
(43) Pub. Date: Jul. 11, 2013

(54) Systems and Methods for Providing Disclosures to Customers

(71) Applicant: STEVEN LEUCK, Santa Cruz, CA (US)

(72) Inventor: STEVEN LEUCK, Santa Cruz, CA (US)

(21) Appl. No.: 13/491,882

(22) Filed: Jun. 8, 2012

Related U.S. Application Data
(60) Provisional application No. 61/584,329, filed on Jan. 9, 2012.

(51) Int. Cl. G06Q 30/06; G06Q 20/20

(52) U.S. Cl. 705/24; 705/26.1

(57) ABSTRACT

In general, the present invention is directed to systems and methods of providing disclosures or information associated with goods or services. Methods in accordance with some embodiments of the present invention may include receiving at a processor an indicia associated with the transaction; determining by the processor disclosures or information based on the indicia; providing the one or more disclosures or information to the customer. In accordance with some embodiments of the present invention, methods of providing disclosures or information associated with goods or services obtained in a transaction conducted at a point-of-sale may include: processing by the POS the transaction; generating or determining an identifier of the transaction; communicating between the POS and a third party processor the identifier of the transaction; receiving at the POS indicia associated with the disclosures or information; communicating between the POS and the customer the indicia associated with the disclosures or information.

### RELATED APPLICATIONS

This application claims priority to U.S. Provisional Patent Application 61/584,329, filed on Jan. 9, 2012.

### BACKGROUND OF THE INVENTION

The present invention is generally directed to systems and methods for providing information to a user in audio or visual format. Specifically, the present invention is directed to providing such information to a user in a digital format, for example, in an audio or text file, or by providing a link to access such information stored in a digital format with a third party.

There are many situations in which parties to a transaction should be apprised of certain information or disclosures. For example, information may be provided to a recipient of certain medications or medical procedures. Similarly, disclosures may be provided to parties to certain transactions, such as the purchase or rent of property, or the purchase of certain investment vehicles. Information and disclosures may also be conveyed to parties regarding certain warranties, activities, and/or limitations. In other words, there are numerous times when it is required, advisable, prudent, or merely desirable to provide a party, customer, or user with certain information.

The provision of such information may be, for example, mandated by law or policy. For example, the Omnibus Reconciliation Act of 1990 (OBRA-90, Public Law 101-508, 104 Stat. 1388, enacted Nov. 5, 1990), included mandates for the states to improve understanding of medications by Medicaid beneficiaries for whom they were prescribed and dispensed. Such counseling generally requires that all new prescriptions and any changes in old prescriptions be accompanied with patient counseling. While such counseling requires a certain degree of interactivity between the pharmacist and the patient, at least a portion of the pharmacists obligation is informing the patient of various informational aspects of the medications at issue.

Moreover, varied consumer transactions have been migrating from the typical transaction at a cash-register point of sale (POS) in a brick-and-mortar store to transactions conducted over the Internet, telephone, applications, or other remote transactions. Even the business models of pharmacies have been evolving in such directions. In such circumstances, the opportunities for direct patient counseling or advising may be limited. In order to provide the adequate amount of information to the patient, the delivery of such medications often includes large amounts of printed information, which is costly to print and ship. Accordingly, an alternative mechanism to provide customers and patients with such information is desirable.

Similarly, in certain transactions such as the purchase of real property, the amount of disclosures that the buyer must be presented with is often overwhelming. Disclosures may be driven by the type of purchase (e.g., residential purchases), the state of purchase (e.g., the State of California requires numerous state-specific disclosures), applicable state and federal agencies (e.g., disclosures regarding environmental impact such as mandated by CERCLA or RCRA), the location of the purchase (e.g., agricultural disclosures), the membership of parties involved (e.g., disclosures required by the National Association of Realtors, etc.), and/or any other types of disclosures. Accordingly, there is a need for a better and more efficient mechanism of providing such disclosures in a more efficient manner.

In addition to required disclosures and information, various health care providers and employers have learned that empowering its members/employees regarding personal health decisions often results in less burden on the providers and health care system (which assists employers in reducing costs associated with missed work time, inefficiencies, etc.). Accordingly, many health care providers and employers provide employees with various programs and wellness tools to assist the employees in managing their health.

However, such programs generally have a drawback in providing patient and medication specific counseling or information. Instead, members/employees are often left to researching medication on their own, typically utilizing the Internet which is not consistently accurate. Accordingly, there is a need for health care providers and employers to provide members/employees with information specifically targeted at the member/employee and applicable medications.

Accordingly, there is a need for a mechanism in providing efficient information and/or disclosures that may be required, advisable, or merely helpful to certain transactions or actions.

### SUMMARY OF THE INVENTION

Aspects in accordance with some embodiments of the present invention may include a method of providing disclosures or information to a customer, the disclosures or information being required or appropriate to a transaction, the method comprising: receiving at a processor an indicia associated with the transaction; determining by the processor one or more required or appropriate disclosures or information based on the indicia; providing the one or more required or appropriate disclosures or information to the customer.

Additional aspects in accordance with some embodiments of the present invention may include a method of providing disclosures or information to a customer, the disclosures or information being associated with goods or services obtained in a transaction, the method comprising: receiving at a processor information sufficient to identify the customer, the processor determining if the customer is eligible to receive disclosures or information; receiving at a processor an indicia associated with one or more of the goods or services; determining by the processor one or more required or appropriate disclosures or information based on the indicia; providing a digital file comprising the one or more required or appropriate disclosures or information in an audio format to the customer.

Moreover, in accordance with some embodiments of the present invention, aspects may include a method of providing disclosures or information to a customer, the disclosures or information being associated with goods or services obtained in a transaction conducted at a point-of-sale (POS), the method comprising: processing by the POS the transaction comprising the goods or services; generating or determining an identifier of the transaction; communicating between the POS and a third party processor and conveying the identifier of the transaction to the third party processor; receiving at the POS indicia associated with the disclosures or information associated with goods or services obtained in the transaction; communicating between the POS and the customer the indicia associated with the disclosures or information associated with goods or services obtained in the transaction.

These and other aspects will become apparent from the following description of the invention taken in conjunction with the following drawings, although variations and modifications may be effected without departing from the spirit and scope of the novel concepts of the invention.

### BRIEF DESCRIPTION OF THE DRAWING

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary flow of a method of providing a user with information a digital format, in accordance with some embodiments of the present invention.

FIG. 2 illustrates an exemplary system of providing a user with information a digital format, in accordance with some embodiments of the present invention.

FIG. 3 illustrates an exemplary flow of a method of providing a user with information a digital format, in accordance with some embodiments of the present invention.

FIG. 4 illustrates an exemplary system of providing a user with information a digital format, in accordance with some embodiments of the present invention.

FIG. 5 illustrates an exemplary method of providing a user with information a digital format, in accordance with some embodiments of the present invention.

FIG. 6 illustrates an exemplary method of providing a user with information a digital format, in accordance with some embodiments of the present invention.

FIG. 7 illustrates an exemplary system of providing a user with information a digital format, in accordance with some embodiments of the present invention.

FIG. 8 illustrates an exemplary system of providing a user with information a digital format, in accordance with some embodiments of the present invention.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

The disclosures or information discussed herein may comprise any information that relevant to, or associated with certain goods, services, a transaction type, or the status of one or more of the parties. For example, certain medications may prompt specific disclosures or information that should be conveyed to the customer or recipient of the medications. Similarly, it may be prudent or desirable to inform patients about to undergo, or who have undergone certain medical procedures, about certain disclosures or information regarding the procedure, after-care, etc. Certain transaction types of may prompt disclosures—for example, the purchase of real property or certain investment devices may prompt specific disclosures. Finally, the status of one or more of the parties may prompt certain disclosures. For example, pharmacists may be required by various agencies to provide certain counseling sessions. Similarly, investment managers or attorneys may be required to advise when tax advice is, and is not, being given. Similarly, the status of the customer or recipient of the goods or services may make certain information or disclosures necessary, desirable, or prudent. For example, customers who fall into certain groups—such as senior citizens—may be provided with additional information or disclosures. Moreover, the native language of the customer or recipient may prompt disclosures or information to be provided in such native language in order to fully convey the disclosures or information without fear of translation errors, mistakes, or misunderstandings.

A more specific example of such disclosures may be seen in the recommendations provided by the American Society of Health System Pharmacists (“ASHP”) regarding pharmacist based medication counseling. The ASHP publishes specific guidelines on what should be included. See ASHP Guidelines on Pharmacist-Conducted Patient Education and Counseling. Specifically, the ASHP recommends informing the patient on approximately sixteen topics. Such topics include the medication's trade name, generic name, common synonym, or other descriptive name(s) and, when appropriate, its therapeutic class and efficacy. The medication's use and expected benefits and action, which may include whether the medication is intended to cure a disease, eliminate or reduce symptoms, arrest or slow the disease process, or prevent the disease or a symptom. The medication's expected onset of action and what to do if the action does not occur. The medication's route, dosage form, dosage, and administration schedule (including duration of therapy). Directions for preparing and using or administering the medication. This may include adaptation to fit patients' lifestyles or work environments. Action to be taken in case of a missed dose. Precautions to be observed during the medication's use or administration and the medication's potential risks in relation to benefits. For injectable medications and administration devices, concern about latex allergy may be discussed. Potential common and severe adverse effects that may occur, actions to prevent or minimize their occurrence, and actions to take if they occur, including notifying the prescriber, pharmacist, or other health care provider. Techniques for self-monitoring of the pharmacotherapy. Potential drug-drug (including nonprescription), drug-food, and drug-disease interactions or contraindications. The medication's relationships to radiologic and laboratory procedures (e.g., timing of doses and potential interferences with interpretation of results). Prescription refill authorizations and the process for obtaining refills. Instructions for 24-hour access to a pharmacist. Proper storage of the medication. Proper disposal of contaminated or discontinued medications and used administration devices. Any other information unique to an individual patient or medication.

Additional information may be appropriate when pharmacists have authorized responsibilities in collaborative disease management for specified categories of patients. Depending on the patient's disease management or clinical care plan, the following may be covered: the disease state—whether it is acute or chronic and its prevention, transmission, progression, and recurrence; expected effects of the disease on the patient's normal daily living; and recognition and monitoring of disease complications.

In other words, the disclosures or information discussed herein may take many forms, and may be required, advisable, or recommended by various groups, agencies, governmental bodies, etc. Alternatively, provision of the disclosures or information may desirable by one party, perhaps only to be prudent or cautious.

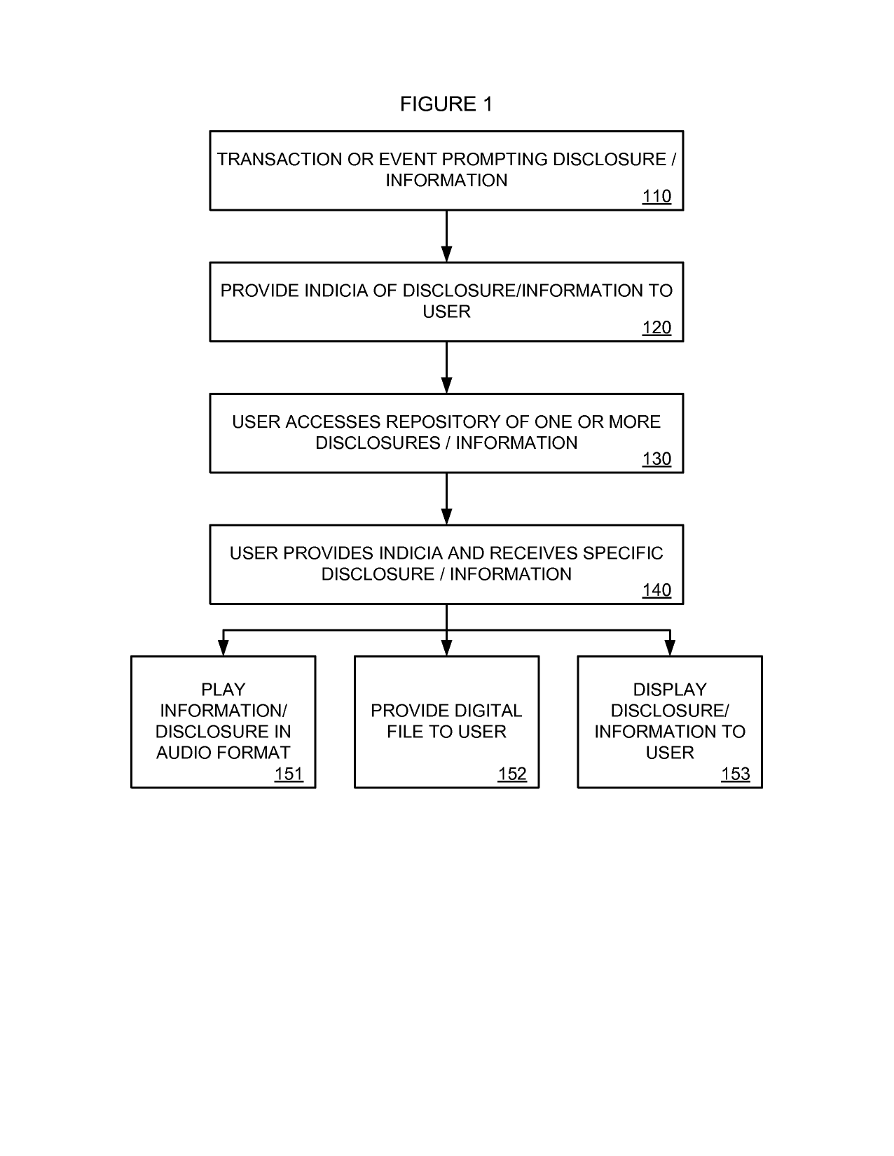

With reference to FIG. 1, a method of providing a user with information in a digital format will now be discussed. The method may begin with a transaction or event prompting a required or recommended disclosure 110, or any other event triggering the need or desire to provide a user with certain information. Examples of such a transaction or event may include, but are not limited to: the provisions of medications either by prescription or over-the-counter; medical services and/or treatment, which a user may either have to acknowledge certain disclosures or information in advance, or may receive information following such services and/or treatment (e.g., instructions for wound care, physical limitations, etc.; transactions involving real estate—e.g. buying, selling, or leasing real property—where specific disclosures may be required or desirable; the purchase or sale of certain investment items or securities, where disclosures may be required or helpful; repairs to various consumer or business products; warranties or limitations of any goods or services sold, rented, leased, or used—e.g., setting forth warranty information such as what is and is not covered, or setting forth limitations of use of any such goods or services; and any other area where it may useful, prudent, or required to provide users with information or disclosures.

Note that it is anticipated that areas of such disclosure may comprise those in which disclosure is not necessary, but may be desirable to one or more of the parties. For example, it is contemplated that a medical professional may wish to have confirmation of his or her patient receiving certain information. Such confirmation may provide the medical professional with peace of mind, and may also be used to support any allegations of malpractice, or even provide for a reduced malpractice premium with professional liability providers.

Similarly, and as discussed in greater detail above, disclosures are at times mandated—for example in the case of Medicare and/or Medicaid beneficiaries, counseling is mandated by OBRA-90 (as noted above). Moreover, professional organizations—such American Society of Health System Pharmacists (ASHP) may recommend counseling and may provide educational guidelines. In such situations, the step of providing disclosure of information to customers may comport with published professional guidelines. Moreover, it is contemplated that the systems and methods of the present invention may operate in conjunction with an interactive website, chat-room, phone line, or other such personal interaction so that guidelines and requirements with regard to “counseling” may also be met.

Regardless of the type of transaction or event at 110, the method may progress at 120 to providing to the user an indicia of disclosure or information. At 130 the user may access a repository of information. The repository of information may comprise one or more disclosures or pieces of information.

At 140 the user may provide the indicia to the repository (or a processor connected to or in association with the repository). In response, the user may receive specific disclosure or one or more pieces of information associated with the indicia. The user may receive this information in several ways. For example, at 151 the user may receive the disclosure or information in an audio format—such, for example, through the playing of an audio file. At 152, the user may receive the information for saving on the user's own device. In such circumstances, it is contemplated that the user may download the information in an audio, video, or text format. At 153 the user may be presented with a display of the information, but may not be able to save the information on their own device.

Many variations and modifications of this method are contemplated. For example, the transaction or event at step 110 may occur at a point-of-sale (POS). A user with a device with wireless or near-field (e.g., radio frequency identification (RFID) transmission) capability may receive the information on the user device. This may occur automatically with the purchase transaction at the POS, or may be initiated through user prompts at the POS or user device, or through physical contact of the device with the POS or a processor near-field equipped device associated with the POS. Such communication may present the digital file for download onto the user's device, or may display the information. Such communication is contemplated between mobile phones, smart phones, personal digital assistants, tablets, e-readers, laptops, portable gaming consoles, and any other electronic device that may be capable of wireless communication.

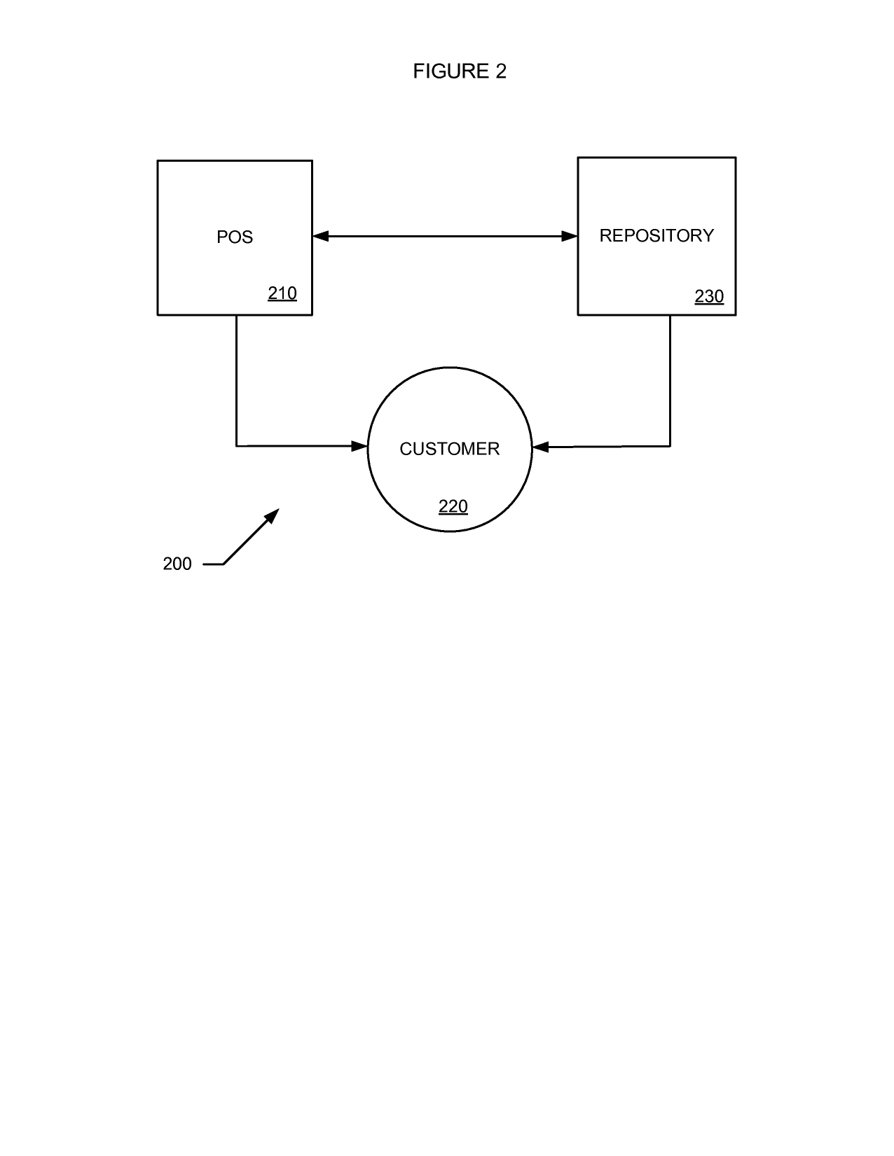

With reference to FIG. 2, a system 200 in accordance with some embodiments of the present invention will now be discussed. System 200 may comprise a POS 210, the customer 220, and a database 230. POS 210 may comprise any point of sale system as known in the art, for example a check out terminal at a merchant location, an interactive website on the Internet or other network, or may occur over a telephone system, such as an ordering a product from a catalog. Customer 220 may be the party purchasing quarrying renting or otherwise having access to any goods or services giving rise to the transaction or event prompting disclosure of certain pieces of information. Database 230 may comprise any database or file repository which may store and or save one or more pieces of information or disclosure elements. During operation of system 200 customer 220 may be a party to a transaction that POS 210 during which customer 220 may receive an indicia or identifier. The indicia or identifier may identify the specific disclosures and/or pieces of information relevant to and/or associated with the transaction conducted at POS 210. Alternative leave the indicia or identifier may identify the transaction that occurred at POS 210 which may be for one or more goods or services giving rise to one or more disclosures are pieces of information. Accordingly the identifier may identify the overall transaction and upon the customer 220 presenting the identifier to the database 230, the database 230 may access multiple disclosures and/or pieces of information relevant to each goods or services purchased at the POS 210.

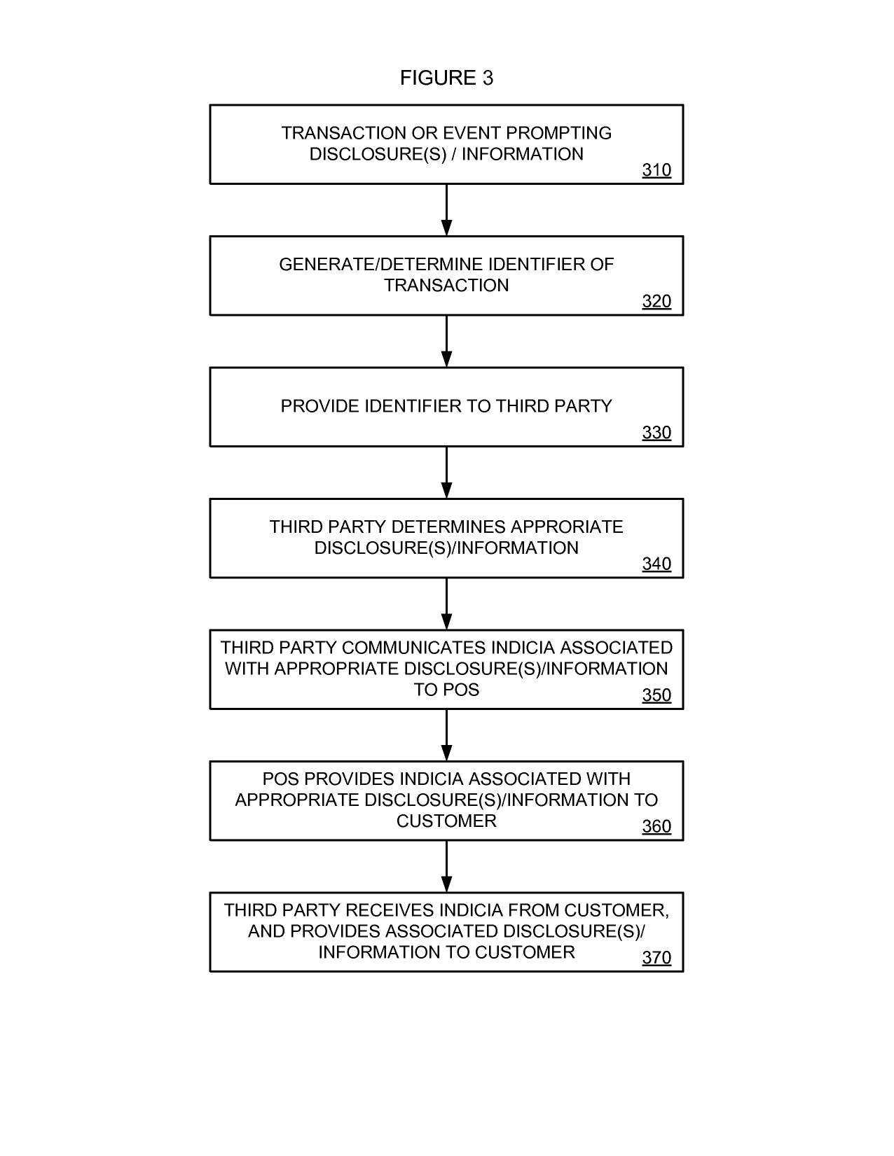

With reference to FIG. 3 method in accordance with some embodiments of the present invention will now be discussed. The method may begin at step 310 where a transaction or event at a point of sale may occur prompting a disclosure or certain pieces of information.

At step 320 the POS may generate or determine one or more identifiers. The one or more identifiers may relate to each product or service purchased in the transaction at the point-of-sale that 310, or alternatively a single identifier may be assigned to the overall transaction. At step 330 the POS may provide the identifier of the transaction, or identifiers of each product or service purchased at the transaction, to third-party. The third party may be associated with the point-of-sale, with the provider of goods or services purchased at point-of-sale, or may be an unrelated party that has an interest in the transaction. For example, although not a party to a transaction between a customer and a pharmacy comprising the purchase of over-the-counter or prescription medications, a healthcare provider or HMO may have an interest in providing its members with certain information and/or disclosures regarding each medication purchased.

At step 340 the third party may determine, based on the identifier or identifiers received from the user, appropriate specific disclosures and/or information. For example, the third-party may access a database or repository of such disclosures of information and may identify the appropriate disclosures or information based upon matching the identifier received from the POS. At step 350 the third party may communicate back to the POS indicia associated with one or more appropriate specific disclosures or pieces of information.

At step 360 the POS may conveyed to the customer the indicia receiving the third-party. This indicia may be received by way of printing on a receipt, printing on other documents, aurally conveying the indicia to the customer, or conveying the indicia to the customer and any other manner. At step 370 third-party may receive from the user the indicia and may accordingly provide the user the appropriate disclosures and/or pieces of information associated with the indicia.

In this manner the provision of disclosures and/or specific information relevant to goods or services purchased by a customer may be handled by a third party that is not a party to the purchase transaction.

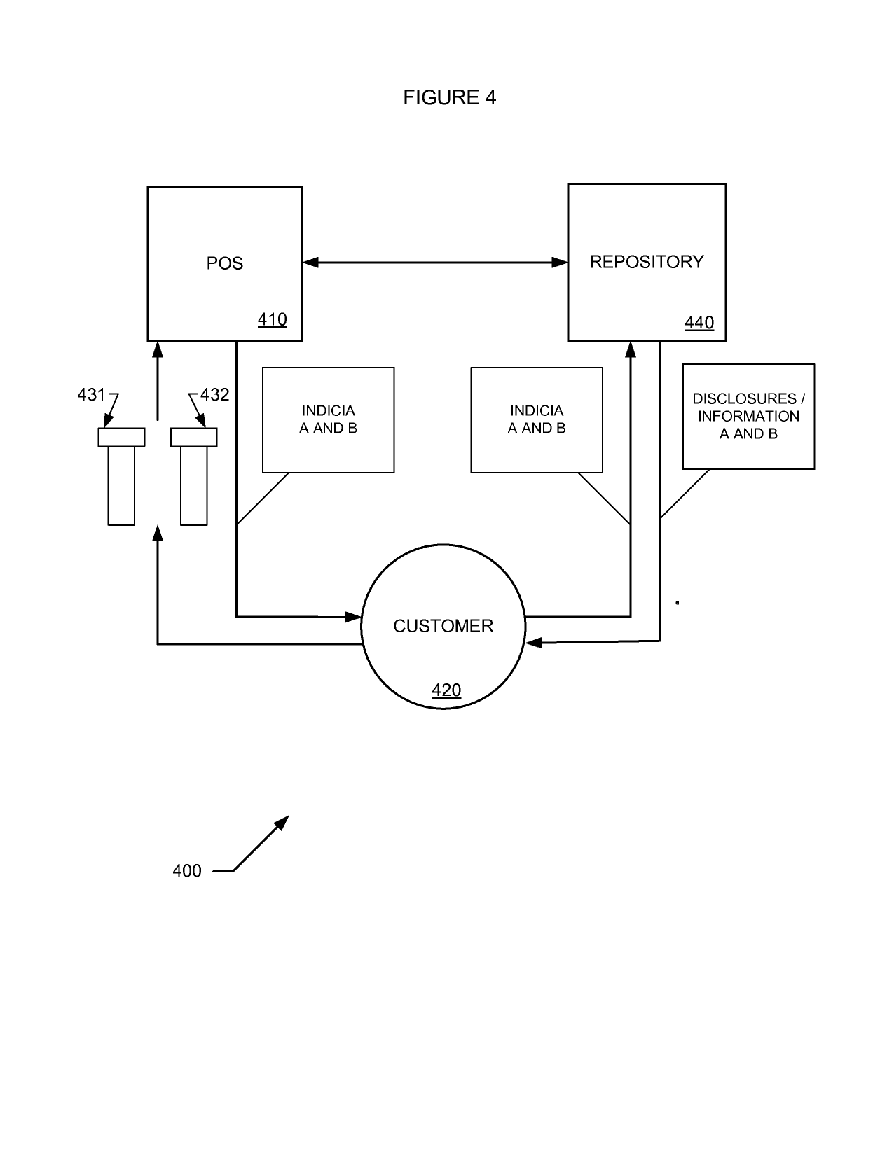

With reference to FIG. 4, a system 400 in accordance with some embodiments of the present invention will now be discussed. System 400 may comprise a POS 410, a user 420, goods or services purchased 430, and a repository 440. POS 410 may comprise any sort of POS as known in the art, and as discussed in more detail above. User may comprise any person or entity purchasing goods or services 430 from POS 410. Goods or services 430 may, for example, comprise items 431 and 432. As shown in FIG. 4, items 431 and 432 may comprise, for example, medication. Repository 440 may be any sort of database or other information store that may comprise one or more disclosures and/or pieces of information related to goods or services 430.

The operation of system 400 may be similar to the method disclosed above with regard to FIG. 3. In accordance with some embodiments of the present invention, during operation of system 400, customer 420 may select items 431 and 432 for purchase at POS 410. Either as part of the purchase transaction, or in a separate transaction following the purchase transaction, POS 410 may be in communication with repository 440, and may conveyed to repository 440 identifiers of items 431 and 432. In response, repository 440 may determine disclosures and/or specific pieces of information related or associated with items 431 and 432. Repository 440 may identify indicia 431A and 432B related to the appropriate disclosures and/or specific pieces of information. Repository 440 may convey this information back to POS 410, which may in turn convey this information to customer 420.

Customer 420 may then, at a later time, communicate with repository 440 in provide repository 440 with indicia 431A and 432B. repository 440 may determine the specific disclosures and/or pieces of information related to indicia 431A and 432B, and may provide user 420 with such disclosures and/or pieces of information. The provision of such disclosures and/or pieces of information may occur by way of repository 440 conveying digital files to user 420, or by repository 440 displaying or presenting to user 420 the disclosures and/or pieces of information.

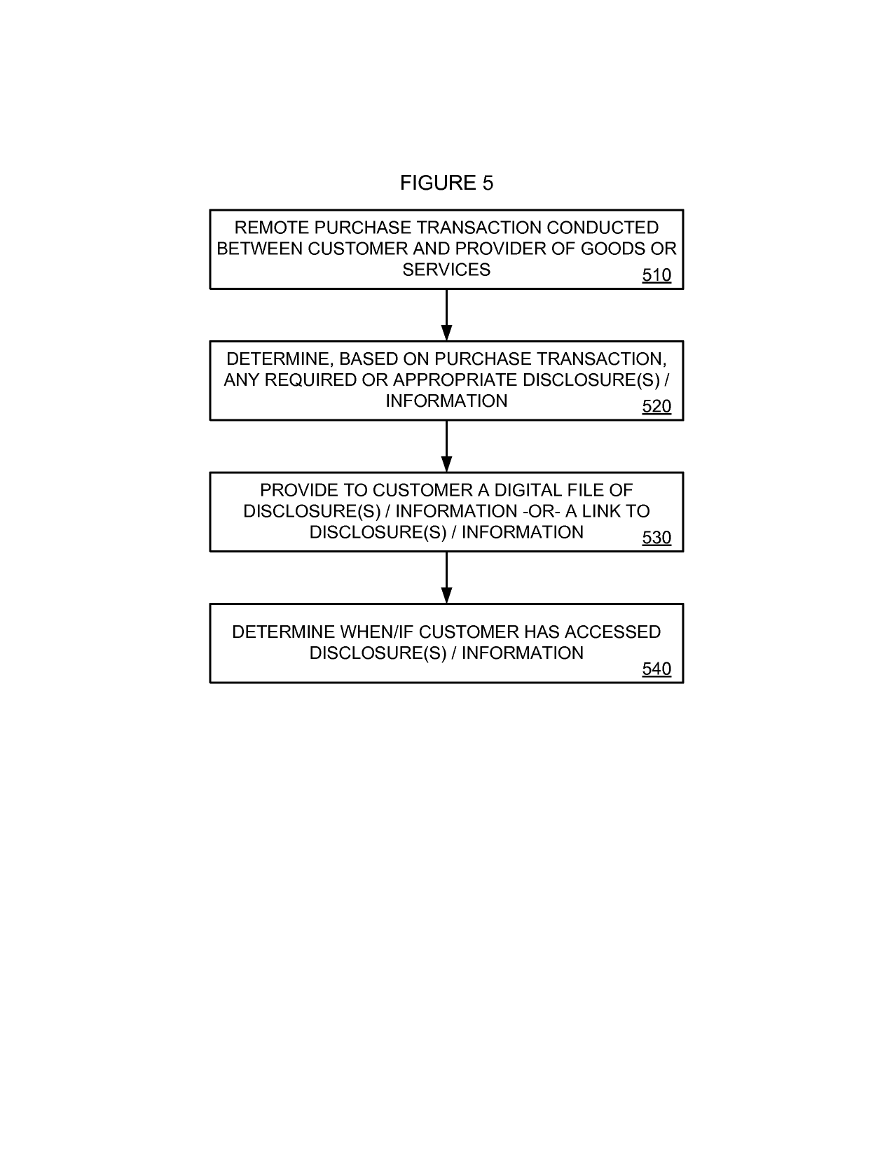

With reference to FIG. 5, a method in accordance with some embodiments of the present invention will now be discussed. At step 510 a remote purchase transaction may be conducted between the customer and the provider of goods or services. For example, such remote purchase transaction may occur over the Internet, via telephone (for example, as in a catalog order), through a purchase application on a tablet or smart phone, or through any other means in which the customer is not any immediate geographic proximity with the provider of goods or services from whom the purchase takes place. At step 520 the provider of goods or services may determine, based on the purchase transaction, any required or appropriate disclosures. At step 530 the provider of goods or services may provide to the customer a digital file of the required or appropriate disclosures. Alternatively, at step 530 the provider of goods or services may provide to the customer a link to the required or appropriate disclosures. When a link to the required or appropriate disclosures is provided, the customer may have to access the required or appropriate disclosures by clicking or otherwise selecting the link provided.

At step 540 the provider of goods or services may determine when or if the customer access the required or appropriate disclosures. In this manner, the provider of goods or services may maintain records of which customers reviewed the required or appropriate disclosures, and when such review occurred.

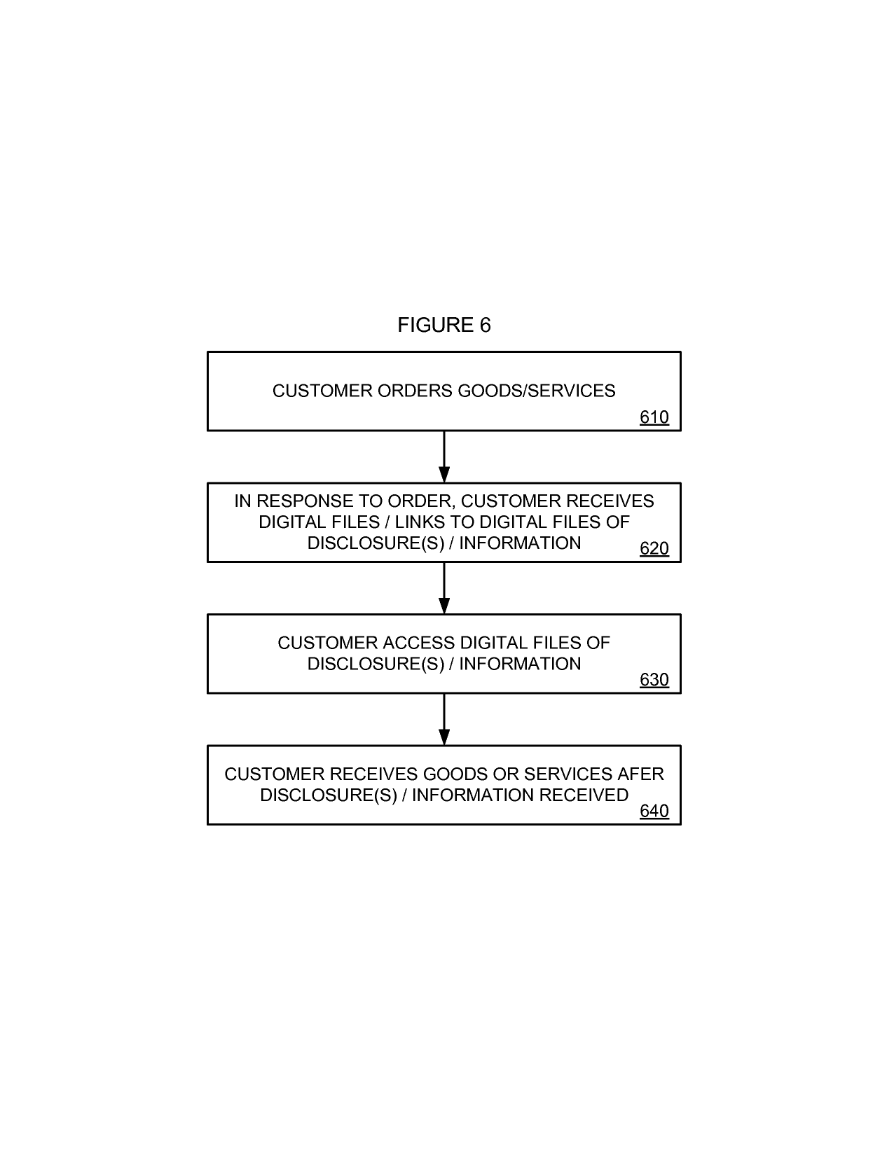

With reference to FIG. 6 a method 600 in accordance with the present invention will now be discussed. In general, method 600 requires a customer to access or review the required or appropriate disclosures before the goods or services giving rise to the required or appropriate disclosures are provided to the customer. Specifically, at step 610 a customer may order goods or services. The ordering of goods or services may occur at a POS, or may occur during a remote purchase transaction, such as those discussed above with regard to FIG. 5. In response to the order, at step 620, the customer may receive digital files of required or appropriate disclosures. Alternatively, at step 620, the customer may receive links to such digital files. At step 630 the customer may access or review the digital files of the required or appropriate disclosures. After the customer has access or reviewed the digital files of the required or appropriate disclosures, the provider of the goods or services ordered by the customer may be released, and either provided to or shipped to the customer 640.

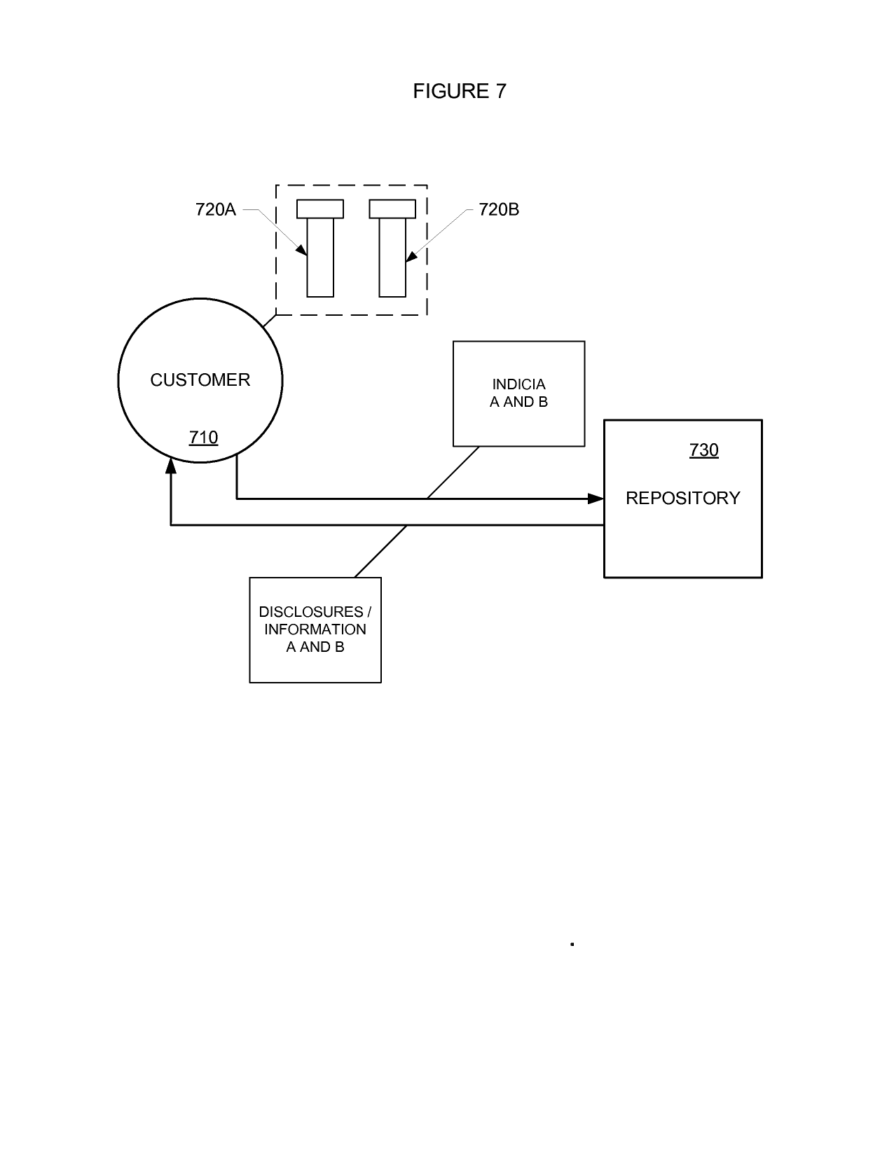

With reference to FIG. 7 a system 700 and accordance with some embodiments of the present invention will now be discussed. In general, system 700 may be employed where a customer directly accesses a repository of disclosures are information, in order to gain access to information pertaining to goods or services purchased or otherwise obtained by the customer 710 in a transaction on related to the repository 730. Specifically, system 700 may comprise a customer 710, one or more goods or services 720, repository 730, and required or appropriate disclosures 740. In operation customer 710 may purchase or otherwise obtain goods or services 720A and 720B. customer 710 may then communicate with repository 730, and provide repository 730 with information sufficient to identify goods or services 720A and 720B. repository 730 may then determine information and/or disclosures related to goods or services 720A and 720B, and may convey such information and/or disclosures to customer 710. In this situation, customer 710 may have a relationship with repository 730. For example, customer may subscribe to repository 730, or may have access to repository 730 through a subscription of customer's employer, healthcare provider, or through customer's membership in a certain membership group (for example, but not limited to, customer loyalty programs, AARP, Medicare or Medicaid eligibility, or any other group or organization).

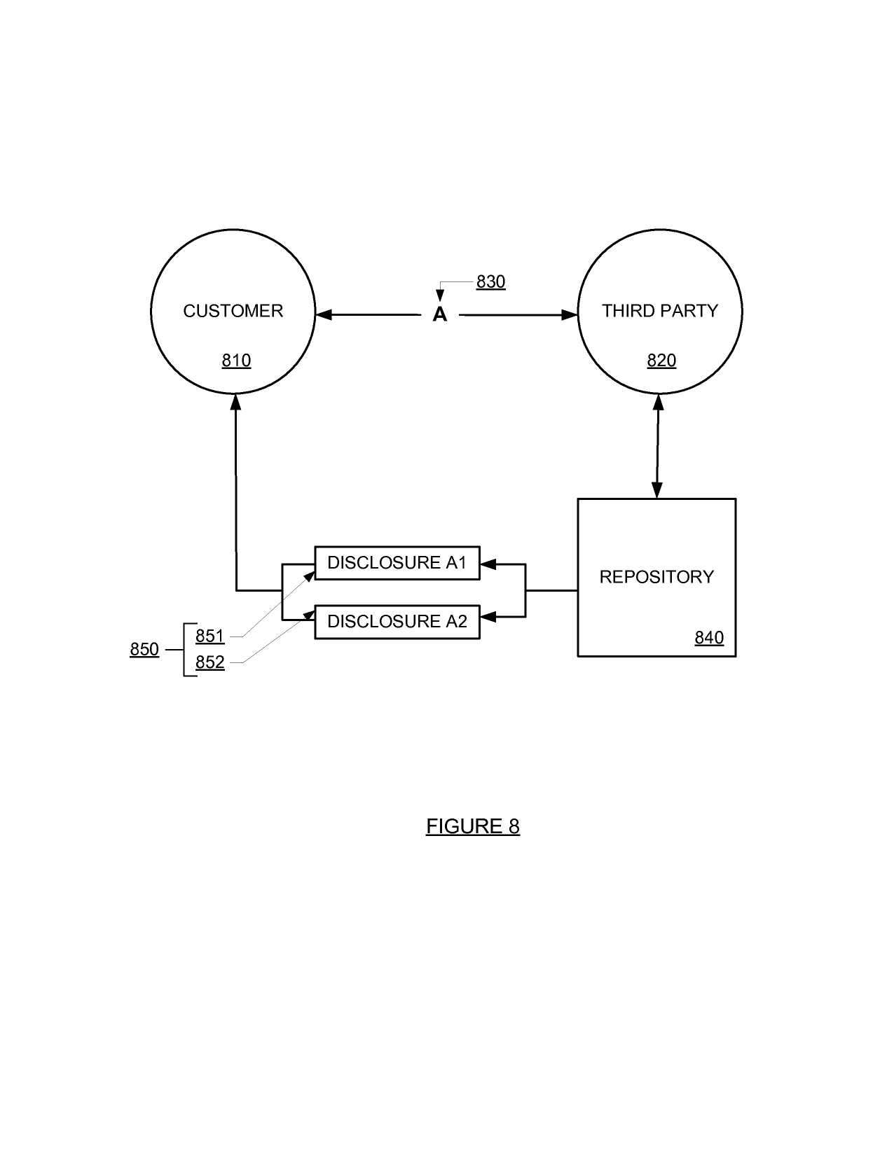

With reference to FIG. 8 a system 800 and accordance with some embodiments of the present invention will now be discussed. In general, system 800 may be utilized in circumstances where disclosures and/or information are relevant to the transaction conducted between a customer 810 and an additional party 820. Specifically, system 800 may comprise a customer 810, an additional party 820, a transaction 830, repository 840, and disclosures or certain pieces of information 850.

Customer 810 may be party to a transaction 830 involving third-party 820. Examples of transaction 830 may include, but are not limited to: real estate transactions, repair transactions, medical procedures, investment transactions, transactions involving certain worn key information, transactions were limitations of goods or services sold may be required or desirable, and transactions involving dangerous products or services. Either as part of transaction 830, prior to transaction 830, or following transaction 830, third-party 820 may communicate with repository 840. Third-party 820 may identifies certain disclosures 851, 852 that may be associated with or relevant to transaction 833rd repository 840 may then communicate with customer 810, in order to convey to customer 810 disclosures 851, 852.

For example customer 810 may be utilizing a real estate agent to assist in conducting the real estate transaction 830. The real estate agent 820 may be required or recommended by law or policy, to disclose certain items to customer 110. Rather than burden customer 810 with multiple formats, pieces of information, or other such disclosures, real estate agent 820 may work with repository 840 in order to convey to customer 810 disclosures 851, 852 by way of digital file sent to the customer's computer, tablet, smart phone, or other device.

Similarly transaction 830 may require certain disclosures 851, 852. For example customer 810 may be purchasing investments or securities utilizing third-party 820 of the sales agent. Third-party 820 may be required or may find it desirable to convey to customer 810 certain disclosures 851, 852 as part of transaction 830. System 800 may accordingly be used to provide the customer 810 disclosures 850 related to a transaction 830 conducted between, or assisted by a third-party 820.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense, and that the scope of the invention will be solely determined by the appended claims.

What is claimed is:

1. A method of providing disclosures or information to a customer, the disclosures or information being required or appropriate to a transaction, the method comprising:
receiving at a processor an indicia associated with the transaction;
determining by the processor one or more required or appropriate disclosures or information based on the indicia;
providing the one or more required or appropriate disclosures or information to the customer.

2. The method of claim 1, wherein the transaction comprises one or more goods or services, and wherein the indicia is associated with the transaction as a whole.

3. The method of claim 1, wherein the transaction comprises one or more goods or services, and wherein the indicia comprises identifiers associated with each goods or services.

4. The method of claim 1, wherein the indicia is based on the identity or status of a party to the transaction.

5. The method of claim 1, wherein the step of determining by the processor one or more required or appropriate disclosures or information based on the indicia comprises identifying a matching indicia in a database, the database comprising one or more disclosures or information.

6. The method of claim 1, wherein the step of determining by the processor one or more required or appropriate disclosures or information based on the indicia comprises identifying one or more disclosures in a database associated with the indicia, the database comprising one or more disclosures or information.

7. The method of claim 1, wherein the step of providing the one or more required or appropriate disclosures or information to the customer comprises conveying a digital file to the customer.

8. The method of claim 7, wherein the digital file is in a format selected from the list consisting of: an audio file; a video file; a graphic file; a text file.

9. The method of claim 7, wherein the digital file is received by a device of the customer, the device selected from the list consisting of: a mobile telephone; a smartphone; a personal data assistant; a tablet; a computer; a gaming console or device; a personal computing device.

10. The method of claim 1, wherein the step of providing the one or more required or appropriate disclosures or information to the customer comprises providing to the customer a link to download the disclosures or information.

11. The method of claim 1, wherein the step of providing the one or more required or appropriate disclosures or information to the customer comprises playing the appropriate disclosures or information to the customer in an audio or video format.

12. A method of providing disclosures or information to a customer, the disclosures or information being associated with goods or services obtained in a transaction, the method comprising:
receiving at a processor information sufficient to identify the customer, the processor determining if the customer is eligible to receive disclosures or information;
receiving at a processor an indicia associated with one or more of the goods or services;
determining by the processor one or more required or appropriate disclosures or information based on the indicia;
providing a digital file comprising the one or more required or appropriate disclosures or information in an audio format to the customer.

13. A method of providing disclosures or information to a customer, the disclosures or information being associated with goods or services obtained in a transaction conducted at a point-of-sale (POS), the method comprising:
processing by the POS the transaction comprising the goods or services;
generating or determining an identifier of the transaction;
communicating between the POS and a third party processor and conveying the identifier of the transaction to the third party processor;
receiving at the POS indicia associated with the disclosures or information associated with goods or services obtained in the transaction;
communicating between the POS and the customer the indicia associated with the disclosures or information associated with goods or services obtained in the transaction.

14. The method of claim 13, wherein the identifier of the transaction identifies the overall transaction.

15. The method of claim 13, wherein the identifier of the transaction identifies each specific goods or services that comprise the transaction.

16. The method of claim 13, wherein the identifier of the transaction identifies one or more specific goods or services included in the transaction.

17. The method of claim 13, wherein the step of communicating between the POS and the customer comprises printing the indicia associated with the disclosures or information on a receipt or other paperwork associated with the transaction.

18. The method of claim 13, wherein the step of communicating between the POS and the customer comprises digitally conveying the indicia associated with the disclosures or information to an electronic device of the customer.

19. The method of claim 13, further comprising:
determining if the customer has received the indicia associated with the disclosures or information;
upon confirmation that the customer has received the indicia associated with the disclosures or information, providing to the customer the goods or services obtained in the transaction.

20. The method of claim 13, further comprising:
receiving at the POS information sufficient to identify the customer;
determining if the customer is eligible to receive disclosures or information associated with the goods or service.
